(19) United States
(12) Patent Application Publication
(10) Pub. No.: US 2010/0215035 A1
(43) Pub. Date: Aug. 26, 2010

(54) EMBEDDED COMMUNICATION APPARATUS, METHOD AND SYSTEM FOR USING THE SAME

(75) Inventor: Peng Jeng Yen, TAIPEI COUNTY (TW)

Correspondence Address: WPAT, PC;INTELLECTUAL PROPERTY ATTORNEYS, 2030 MAIN STREET, SUITE 1300, IRVINE, CA, 92614, US

(73) Assignee: LEADTEK RESEARCH INC., TAIPEI HSIEN (TW)

(21) Appl. No.: 12/577,369

(22) Filed: Oct. 12, 2009

(30) Foreign Application Priority Data
Feb. 20, 2009 (TW) 098105356

(51) Int. Cl. H04L 12/66; G06F 15/16

(52) U.S. Cl. 370/352; 709/228; 726/12

(57) ABSTRACT

A method for network connectivity of an embedded communication apparatus comprises the steps of: registering the domain name and the dynamic IP address of an embedded communication apparatus on a gateway, wherein the dynamic IP address comprises the ID code of the embedded communication apparatus and the domain name of the gateway; connecting an Internet user intending to connect with the embedded communication apparatus according to the domain name thereof to the gateway; dispatching the connection request from the Internet user to the embedded communication apparatus via the gateway; and connecting the embedded communication apparatus to the Internet user.

### BACKGROUND OF THE INVENTION

1. Field of the Invention

The present invention relates to a method for network connectivity and the system using the same, and more particularly, to a method for network connectivity of an embedded communication apparatus and the system using the same.

2. Description of the Related Art

Conventional landline telephone systems utilize public switched telephone network (PSTN) as a medium to connect users. PSTN is a circuit switched network system such that each telephone comprises a unique identification (ID) code, i.e., telephone number. For a long time, PSTN has occupied a majority of telephone systems in use.

However, with the introduction of the technique of voice over the Internet protocol (VoIP), all kinds of application software supporting VoIP, such as Microsoft MSN, Skype, etc., have been developed as well. Unlike conventional landline telephone systems utilizing PSTN as medium, the developed VoIP applications utilize the Internet as medium. Internet is a packet switched network system such that each user owns an Internet Protocol (IP) address on the Internet. Internet users are charged a fixed amount of money for unlimited access time, while PSTN use is charged based on usage time. Therefore, it is more cost effective for users to utilize VoIP for voice transmission. On the other hand, since PSTN is still more popular than the Internet, it is difficult to switch users' habits, and also it is more complicated for users to work on the Internet. Therefore, PSTN retains a predominant technology in the voice transmission market.

Accordingly, an embedded communication apparatus which can connect to both PSTN and the Internet is presented. FIG. 1 shows an embedded communication apparatus 100, which is connected to the PSTN 110 and to the Internet 130 via a router 120. The embedded communication apparatus 100 is a multi-media phone, which not only functions as an easy-use and low-cost conventional telephone, but also can connect to the Internet 130. Therefore, users can access data on the Internet via the embedded communication apparatus 100, and vice versa, users on the Internet can also access data stored in the embedded communication apparatus 100, such as voice files or photo files.

However, since the embedded communication apparatus 100 is connected to the Internet 130 via the router 120 configured by a dynamic host configuration protocol (DHCP) server or a network address translation (NAT) server, the IP address of the embedded communication apparatus 100 is a dynamic IP address. Therefore, the IP address of the embedded communication apparatus 100 varies constantly such that it is difficult for users to connect to the embedded communication apparatus 100. To overcome such issue, there is a need to design a method for network connectivity and the system using the same for embedded communication apparatus.

### SUMMARY OF THE INVENTION

The present method for network connectivity applied to an embedded communication apparatus utilizes a server to store the domain name and IP address of the embedded communication apparatus such that a user can establish connection with the embedded communication apparatus by the server.

The method for network connectivity according to one embodiment of the present invention comprises the steps of: registering a domain name and a dynamic IP address of an embedded communication apparatus on a gateway, wherein the dynamic IP address comprises an ID code of the embedded communication apparatus and a domain name of the gateway; connecting an Internet user intending to connect with the embedded communication apparatus to the gateway according to the domain name of the embedded communication apparatus; dispatching a connection request from the Internet user to the embedded communication apparatus via the gateway; and connecting the embedded communication apparatus to the Internet user.

The network system of an embedded communication apparatus according to one embodiment of the present invention comprises a presence server and an embedded communication apparatus. The presence server is connected to the Internet and stores a domain name and a dynamic IP address of the embedded communication apparatus. The embedded communication apparatus is connected to the presence server via a firewall or router.

### BRIEF DESCRIPTION OF THE DRAWINGS

The objectives and advantages of the present invention will become apparent upon reading the following description and upon referring to the accompanying drawings of which:

FIG. 1 shows an embedded communication apparatus;

FIG. 2 shows a method for network connectivity applied to an embedded communication apparatus according to an embodiment of the present invention;

FIG. 3 exemplifies applying method for network connectivity to an embedded communication apparatus according to an embodiment of the present invention;

FIG. 4 shows a network system of an embedded communication apparatus according to an embodiment of the present invention; and

FIG. 5 shows a user dispatches a request to a presence server for the information of an embedded communication apparatus according to an embodiment of the present invention.

### DETAILED DESCRIPTION OF THE INVENTION

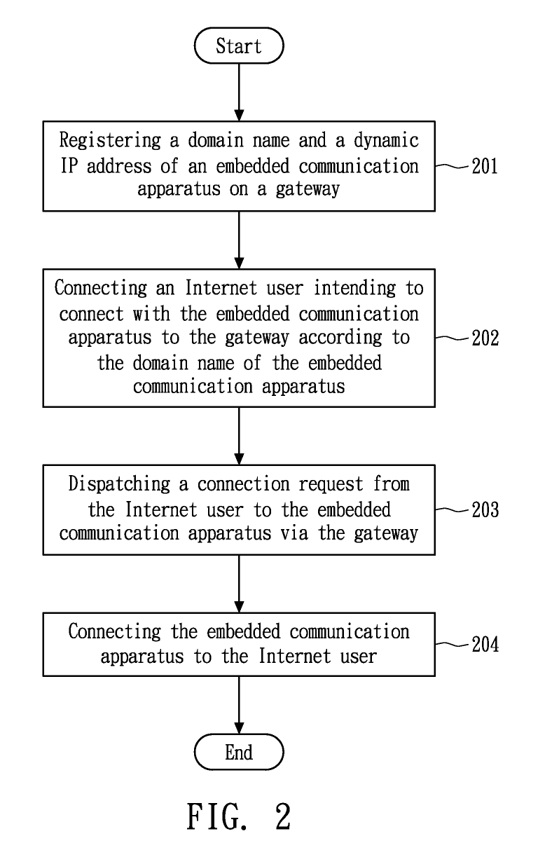

FIG. 2 shows a method for network connectivity applied to an embedded communication apparatus according to an embodiment of the present invention. In step 201, a domain name and a dynamic IP address of an embedded communication apparatus are registered on a gateway, and then step 202 is executed, wherein the dynamic IP address comprises an ID code of the embedded communication apparatus and a domain name of the gateway. In step 202, an Internet user intending to connect with the embedded communication apparatus is connected to the gateway according to the domain name of the embedded communication apparatus, and then step 203 is executed. In step 203, a connection request from the Internet user is dispatched to the embedded communication apparatus via the gateway, and then step 204 is executed. In step 204, the embedded communication apparatus is connected to the Internet user.

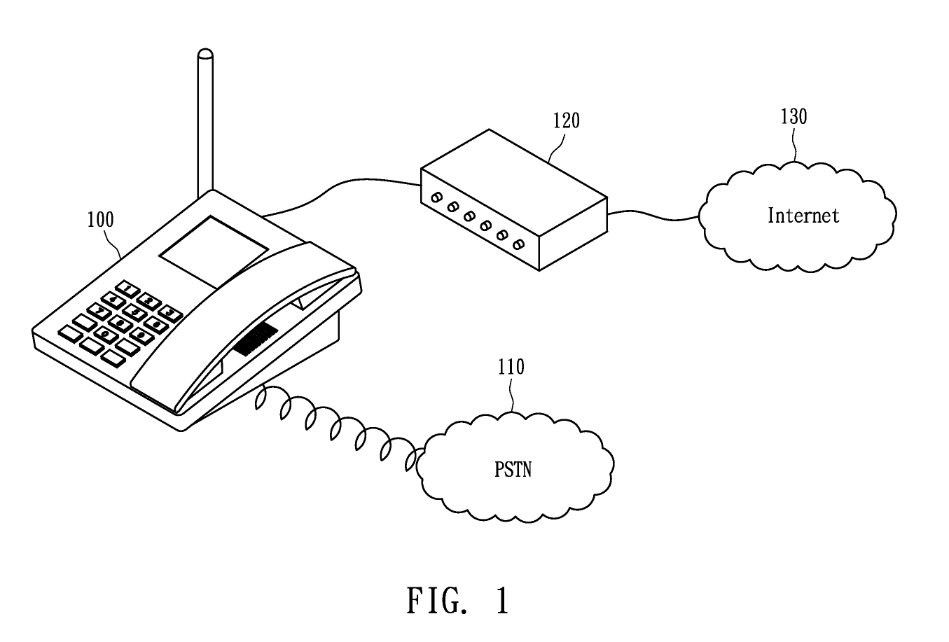

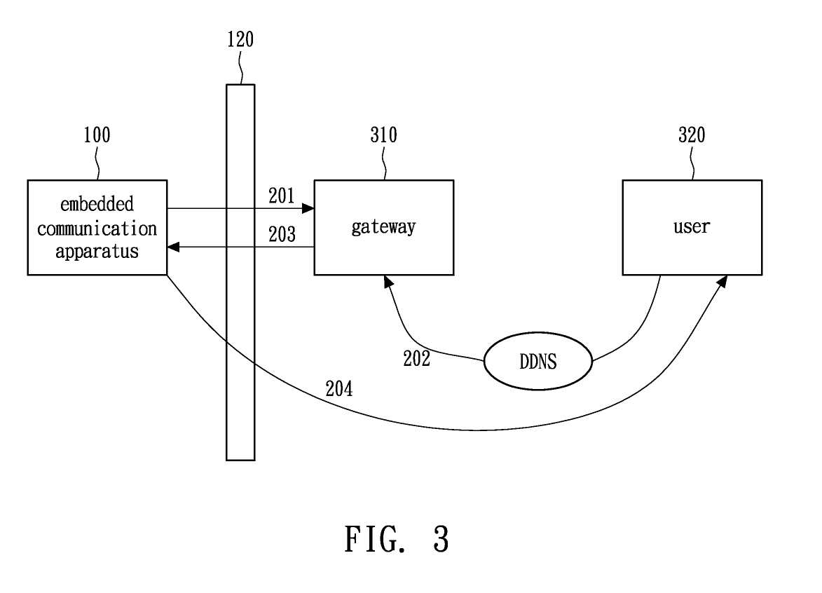

FIG. 3 exemplifies applying method for network connectivity shown in FIG. 2 to the embedded communication apparatus 100 shown in FIG. 1. As shown in FIG. 3, the embedded communication apparatus is connected to the Internet via a router or firewall 120, wherein the router or firewall 120 is a DHCP server or NAT server. In addition, a gateway 310 and an Internet user 320 are connected to the Internet as well. The domain name of the embedded communication apparatus 100 is set as “the ID code of the embedded communication apparatus 100, the domain name of the gateway 310”. In this embodiment, the embedded communication apparatus 100 is a multi-media phone, and therefore the ID code of the embedded communication apparatus 100 is a telephone number, such as 886212345678. The gateway 310 is a reverse hypertext transfer protocol (HTTP) proxy server, and its domain name is abc.com. Therefore, the domain name of the embedded communication apparatus 100 is 886212345678.abc.com.

In step 201, the embedded communication apparatus 100 is connected to the gateway 310 while powering up, and the domain name and the IP address of the embedded communication apparatus 100 are registered on the gateway 310. In step 202, the Internet user 320 intends to connect with the embedded communication apparatus 100. Therefore, the Internet user 320 uses an Internet browser to search for the embedded communication apparatus 100 of the domain name 886212345678.abc.com. The gateway 310 utilizes dynamic domain name system (DNS) technique to connect the Internet user 320 to the gateway 310. In step 203, the gateway 310 searches for the ID code 886212345678 in its database to access the information of the IP address of the embedded communication apparatus 100, and dispatches a connection request from the Internet user 320 to the embedded communication apparatus 100 via the gateway 310. In step 204, the embedded communication apparatus 100 establishes a connection with the Internet user 320 in response to the connection request so as to accomplish the network connectivity.

In one embodiment of the present invention, the method for network connectivity further comprises the step of: periodically reporting the status of the embedded communication apparatus 100 to the gateway 310 after the powering up of the embedded communication apparatus 100 to ensure the gateway 310 has the full knowledge of the status and the most updated information of the embedded communication apparatus 100, such as the updated IP address.

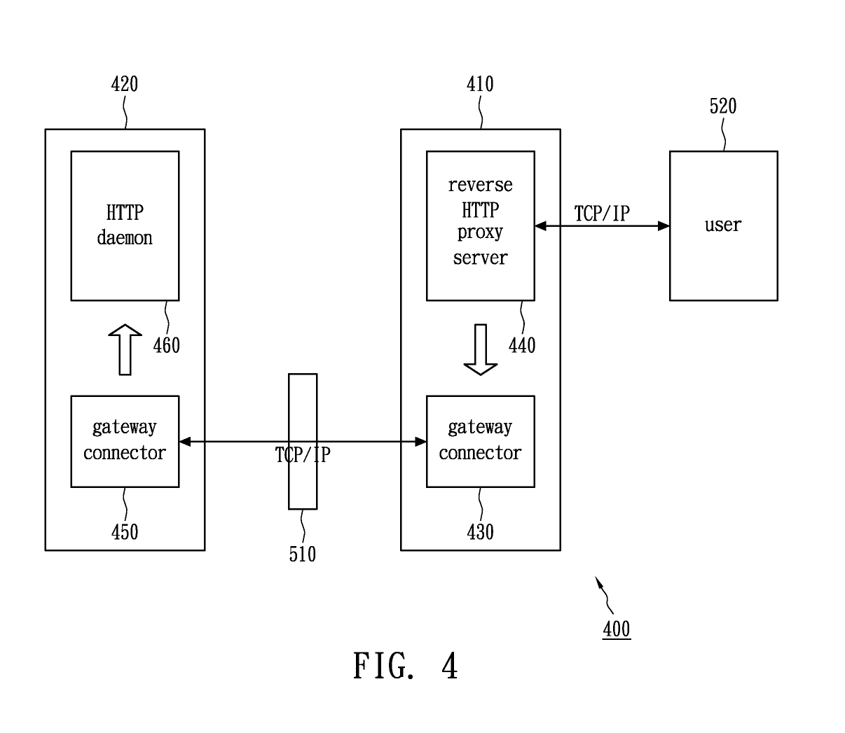

FIG. 4 shows a network system of an embedded communication apparatus according to an embodiment of the present invention. As shown in FIG. 4, the network system 400 comprises a presence server 410 and an embedded communication apparatus 420. The presence server 410 is connected to the Internet, and comprises a gate connector 430 and a reverse HTTP proxy server 440. The embedded communication apparatus 420 is connected to the presence server 410 via a firewall or a router 510 and comprises a gateway connector 450 and an HTTP daemon 460. The gate connector 430 is configured to transmit and receive signals from the embedded communication apparatus 420 via the firewall or the router 510. The reverse HTTP proxy server 440 is configured to dispatch a connection request from an Internet user 520 to the gateway connector 430. The gateway connector 450 is configured to transmit and receive signals from the presence server 410 via the firewall or the router 510. The HTTP daemon 460 is configured to receive and process signals from the gateway connector 450.

In one embodiment of the present invention, the presence server 410 further comprises a database, which is configured to store the domain name and the dynamic IP address of the embedded communication apparatus 420. The gateway connectors 430 and 450 are implemented by software. The router or firewall 510 is a DHCP server or NAT server. The embedded communication apparatus 420 is a multi-media phone.

The method for network connectivity shown in FIG. 2 can be applied to the network system 400 shown in FIG. 4. In step 201, the embedded communication apparatus 420 connects to the presence server 410, the database of which stores the domain name and dynamic IP address of the embedded communication apparatus 420. In step 202, the Internet user 520 uses an Internet browser to search for the embedded communication apparatus 420 according to the domain name of the embedded communication apparatus 420, and the presence server 410 establishes connection with the Internet user 520 by dynamic DNS and transmission control protocol/Internet protocol (TCP/IP) technique. In step 203, the reverse HTTP proxy server 440 dispatches a connection request from the Internet user 520 to the gateway connector 430. The gateway connector 430 connects with the gateway connector 450 via the firewall or the router 510 by using TCP/IP technique to dispatch the connection request. In step 204, the gateway connector 450 dispatches the connection request to the HTTP daemon 460, and the embedded communication apparatus 420 responds to the connection request and establishes connection with the Internet user 520.

In one embodiment of the present invention, the ID code of the embedded communication apparatus 420 acts as an index in the presence server 410, and the index is used to access the database of the presence server 410. The database stores information of the embedded communication apparatus 420, such as the location of the embedded communication apparatus 420 and the physiological data of the user using the embedded communication apparatus 420.

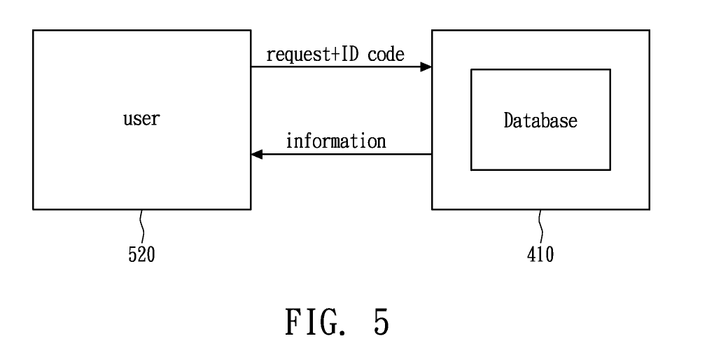

FIG. 5 shows the user 520 dispatches a request to a presence server 410 for the information of the embedded communication apparatus 420 after the network connectivity is established according to the method shown in FIG. 2. The user 520 desires the knowledge of the location of the embedded communication apparatus 420 and thus dispatches the ID code of the embedded communication apparatus 420 and the request for the location of the embedded communication apparatus 420 to the presence server 410. The presence server 410 comprises a database storing the information of the embedded communication apparatus 420, and the information includes the location of the embedded communication apparatus 420. The ID code of the embedded communication apparatus 420 then acts as an index for the information of the embedded communication apparatus 420 stored in the database. The presence server 410 then dispatches the location of the embedded communication apparatus 420 to the user 520.

In conclusion, the present method for network connectivity applied to an embedded communication apparatus establishes connection with users on the Internet without any additional hardware cost of the embedded communication apparatus. Further, other than the ID code of the embedded communication apparatus, users on the Internet are not required to memorize the IP address of the embedded communication apparatus, such that a network connectivity to the embedded communication apparatus analogous to conventional landline telephones can be easily established. Therefore, the convenience thereof is significantly improved.

The above-described embodiments of the present invention are intended to be illustrative only. Those skilled in the art may devise numerous alternative embodiments without departing from the scope of the following claims.

What is claimed is:

1. A method for network connectivity, comprising the steps of:
registering a domain name and a dynamic Internet Protocol (IP) address of an embedded communication apparatus on a gateway, wherein the dynamic IP address comprises an identification (ID) code of the embedded communication apparatus and a domain name of the gateway;
connecting an Internet user intending to connect with the embedded communication apparatus to the gateway according to the domain name of the embedded communication apparatus;
dispatching a connection request from the Internet user to the embedded communication apparatus via the gateway; and
connecting the embedded communication apparatus to the Internet user.

2. The method of claim 1, wherein the domain name of the embedded communication apparatus is an IP address constructed by the ID code of the embedded communication apparatus and the domain name of the gateway.

3. The method of claim 1, wherein the connection between the Internet user and the gateway is via a dynamic Domain Name System (DNS) technique.

4. The method of claim 1, wherein the gateway is a reverse Hypertext Transfer Protocol (HTTP) proxy server.

5. The method of claim 1, wherein the embedded communication apparatus is connected to the gateway via a router or firewall.

6. The method of claim 5, wherein the router or firewall is a dynamic host configuration protocol server or network address translation server.

7. The method of claim 1, wherein the embedded communication apparatus is a multi-media phone.

8. The method of claim 7, wherein the ID code is a phone number of the embedded communication apparatus.

9. The method of claim 1, wherein the ID code acts as an index in the gateway, and the index is used to access information of the embedded communication apparatus.

10. The method of claim 9, wherein the information of the embedded communication apparatus comprises a location of a Global Positioning System (GPS) tracker or a physiological data.

11. The method of claim 1, further comprising the step of:
periodically reporting a status of the embedded communication apparatus to the gateway.

12. An embedded communication apparatus, comprising:
a gateway connector configured to transmit and receive signals from a presence server via a firewall or a router; and
an HTTP daemon configured to receive and process signals from the gateway connector;
wherein the presence server stores a domain name and a dynamic IP address of the embedded communication apparatus, and the embedded communication apparatus is connected to an Internet user through the domain name.

13. The embedded communication apparatus of claim 12, further comprising an ID code, wherein the domain name is constructed by the ID code and a domain name of the presence server.

14. The embedded communication apparatus of claim 12, wherein the gateway connector is implemented by software.

15. The embedded communication apparatus of claim 12, which is a multi-media phone.

16. The embedded communication apparatus of claim 15, wherein the ID code is a phone number of the embedded communication apparatus.

17. The embedded communication apparatus of claim 13, wherein the ID code acts as an index in the presence server, and the index is used to access information of the embedded communication apparatus.

18. The embedded communication apparatus of claim 17, wherein the information of the embedded communication apparatus comprises a location of a GPS tracker or a physiological data.

19. A network system of an embedded communication apparatus, comprising:
a presence server connected to the Internet; and
an embedded communication apparatus connected to the presence server via a firewall or router;
wherein the presence server stores a domain name and a dynamic IP address of the embedded communication apparatus.

20. The network system of claim 19, wherein the domain name of the embedded communication apparatus is constructed by an ID code of the embedded communication apparatus and a domain name of the presence server.

21. The network system of claim 20, wherein the ID code acts as an index in the presence server, and the index is used to access information of the embedded communication apparatus.

22. The network system of claim 21, wherein the information of the embedded communication apparatus comprises a location of a GPS tracker or a physiological data.

23. The network system of claim 19, wherein the presence server comprises:
a gateway connector configured to transmit and receive signals from the embedded communication apparatus via the firewall or the router; and
a reverse HTTP proxy server configured to dispatch a connection request from an Internet user to the gateway connector.

24. The network system of claim 23, wherein the gateway connector is implemented by software.

25. The network system of claim 23, wherein the presence server further comprises:
a database configured to store the domain name and the dynamic IP address of the embedded communication apparatus.

26. The network system of claim 19, wherein the embedded communication apparatus comprises:
a gateway connector configured to transmit and receive signals from the presence server via the firewall or the router; and
an HTTP daemon configured to receive and process signals from the gateway connector.

27. The network system of claim 26, wherein the gateway connector is implemented by software.

28. The network system of claim 19, wherein the router or firewall is a dynamic host configuration protocol server or network address translation server.

29. The network system of claim 19, wherein the embedded communication apparatus is a multi-media phone.
